(19) United States
(12) Patent Application Publication
(10) Pub. No.: US 2026/0072742 A1
(43) Pub. Date: Mar. 12, 2026

(54) ADAPTIVE HEAP CHOICE FOR DYNAMIC RESOURCES

(71) Applicant: ADVANCED MICRO DEVICES, INC., Santa Clara, CA (US)

(72) Inventors: Yong Wu, Ningbo (CN); Cong Xiong, Chengdu (CN); Lei Shen, Shanghai (CN); DongHui Sheng, Shanghai (CN)

(21) Appl. No.: 18/829,803

(22) Filed: Sep. 10, 2024

(51) Int. Cl. G06F 9/50

(52) U.S. Cl. CPC G06F 9/5016

(57) ABSTRACT

A processor system includes a host processor couplable to an accelerated processor and a plurality of memory heaps. The host processor is configured to select a memory heap from the plurality of memory heaps based on processor usage information and in response to a request for a dynamic resource. The host processor is further configured to allocate or use a recycled instance of the dynamic resource in the selected memory heap.

### BACKGROUND

Accelerated processors (AP), such as graphics processing units (GPUs), provide the power needed for rendering high-quality visuals in applications such as video games, virtual reality, and graphical interfaces. The process of rendering involves the use of various dynamic resources, including vertex buffers, index buffers, textures, and constant buffers. These resources are regularly updated by a host processor, such as a central processing unit (CPU), and subsequently utilized by the parallel processor to generate images. Dynamic resources are typically stored in different types of memory heaps, such as local memory (e.g., a parallel processor framebuffer) and a non-local memory (e.g., system random access memory). The allocation and management of these resources involve coordinating the access patterns of both the host processor and the AP to ensure efficient data handling and processing. In a typical system, the host processor updates dynamic resources by writing new data, which the AP then accesses for rendering operations. The allocation of memory for these resources can vary depending on factors such as the type of data, frequency of updates, and hardware configuration. This process involves careful management to maintain smooth and efficient operation, ensuring that both the host processor and the AP have timely access to the necessary data for their respective tasks.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an example processing system configured to implement one or more adaptive heap selection techniques for dynamic resources in accordance with some implementations.

FIG. 2 is a block diagram of an example configuration for device memory and system memory of the processing system of FIG. 1 in accordance with some implementations.

FIG. 3 is a block diagram of an example configuration for a command buffer of the processing system of FIG. 1 in accordance with some implementations.

FIG. 4 is a flow diagram illustrating an example method for adaptively selecting heaps for dynamic resources in accordance with at least some implementations.

### DETAILED DESCRIPTION

In modern graphics rendering systems, dynamic resources are elements frequently updated by the host processor and subsequently utilized as AP inputs for rendering graphics. The dynamic resources are often mapped to acquire a host processor virtual address (VA), enabling efficient updating. These mapping techniques allow the allocation of a new instance of the resource for immediate use, avoiding delays associated with waiting for the AP to idle and reuse a default allocation instance. A significant consideration in these systems is the performance difference between accessing local heap (e.g., AP framebuffer,) and non-local heap (e.g., system memory). For APs, accessing the local heap is substantially faster than accessing the non-local heap, whereas the opposite is true for host processors. Typically, drivers select a fixed preferred heap for dynamic resources, which can lead to suboptimal performance in real three-dimensional (3D) games. This performance impact varies based on whether the system is host processor-bound or AP-bound, which can dynamically change due to variations in game scenes, resolution settings, or platform configurations. For instance, in an AP-bound scenario using a non-local heap for all dynamic resource renaming instances can result in a performance penalty compared to using the host processor-visible local heap. Conversely, in a host processor-bound scenario, using the host processor-visible local heap instead of the non-local heap can cause performance penalty. These examples highlight the need for a dynamic approach to selecting a suitable heap for dynamic resources to achieve suitable performance across different resolutions and scenarios.

The issue is exacerbated in cloud gaming scenarios, particularly with Single Root Input/Output Virtualization (SR-IOV)-based GPU virtualization. In such setups, Virtual Functions (VFs) inherit the graphics capabilities of the physical GPU. For example, with two VFs (2VF), each VF instance shares approximately half of the performance capability of the Physical Function (PF), which represents the physical GPU. Similarly, with four VFs (4VF), each instance receives about a quarter of the PF's capability. Depending on the game settings, an application may be CPU-bound in a 2VF scenario and GPU-bound in a 4VF scenario.

As such, the techniques described herein provide for an adaptive heap choice strategy for dynamic resources in graphics rendering systems. By tracking host processor and AP usage to determine the bound state of the system over a configurable number of frames, a system implementing these techniques dynamically selects the preferred heap for newly requested renaming instances of dynamic resources, thereby optimizing performance across different resolutions and game scenarios. This approach enables optimal performance by dynamically selecting the preferred heap for newly requested renaming instances of dynamic resources based on the current host processor and AP usage state.

As described in greater detail below, the adaptive heap choice techniques described herein include tracking the host processor and AP usage over a configurable number of frames, referred to as “last N frames”, to determine whether the system is currently host processor-bound or AP-bound. This information is used to select the preferred heap for newly requested renaming instances of dynamic resources. For example, if the last N frames are determined to be AP-bound, the techniques described herein return a new renaming instance with a preferred location in the local heap (e.g., AP frame buffer), which is typically faster than accessing non-local heap (e.g., system memory). Conversely, if the last N frames are determined to be host processor-bound, the techniques described herein return a new renaming instance with a preferred location in the non-local heap (system memory). Accordingly, the techniques described herein provide an adaptive heap choice strategy that optimizes performance in dynamic resource allocation by considering changes in host processor and AP usage state.

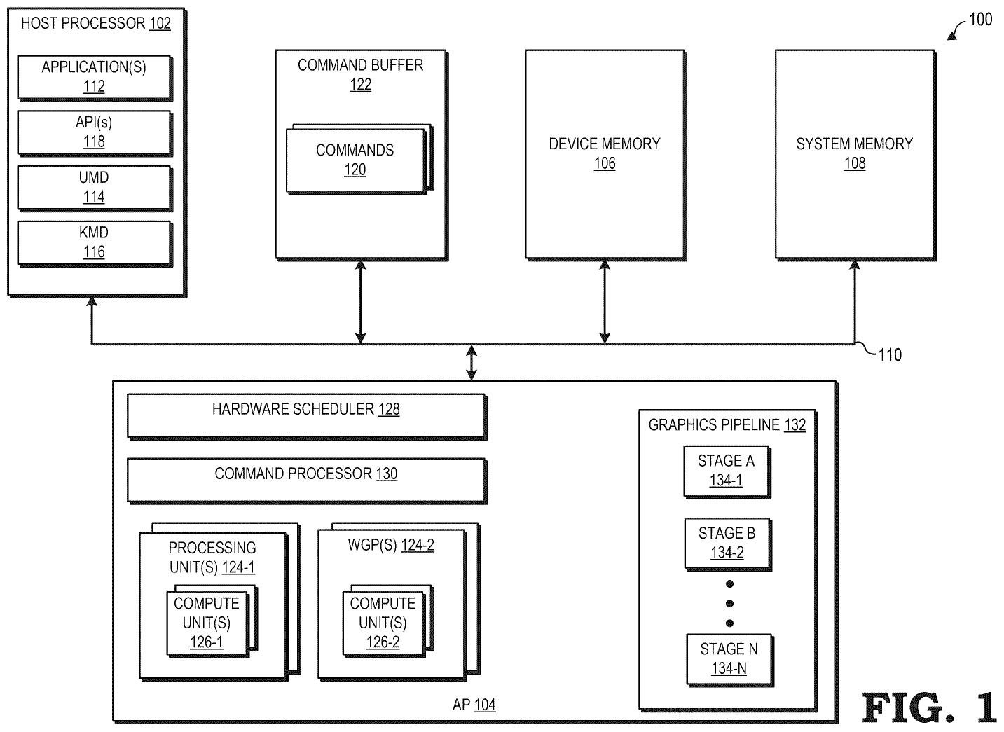

FIG. 1 is a block diagram illustrating a processing system 100 implementing adaptive heap choice techniques for dynamic resources in accordance with some implementations. It is noted that the number of components of the processing system 100 varies from implementation to implementation. In at least some implementations, there is more or fewer of each component/subcomponent than the number shown in FIG. 1. It is also noted that the processing system 100, in at least some implementations, includes other components not shown in FIG. 1 or is structured in other ways than shown in FIG. 1. Also, components of the processing system 100 are implemented as hardware, circuitry, firmware, software, or any combination thereof.

In the depicted example, the processing system 100 includes a host processor 102, such as a central processing unit (CPU), one or more accelerated processors (APs) 104, a device memory 106 utilized by the AP 104, and a system memory 108 shared by the host processor 102 and the AP 104. In at least some implementations, the host processor 102 and the AP 104 are formed and combined on a single silicon die or package to provide a unified programming and execution environment. However, in other implementations, the host processor 102 and the AP 104 are formed separately and mounted on the same or different substrates. In at least some implementations, the AP 104 accepts both compute commands and graphics rendering commands from the host processor 102 or another processor.

The AP 104, in at least some implementations, includes any cooperating collection of hardware, software, or a combination thereof that performs functions and computations associated with accelerating graphics processing tasks, data-parallel tasks, nested data-parallel tasks in an accelerated manner with respect to resources, such as conventional CPUs, conventional GPUs, and combinations thereof. For example, in at least some implementations, the AP 104, combines a general-purpose CPU and a graphics processing unit (GPU). In other implementations, the AP 104 includes one or more parallel processors, such as vector processors, graphics processing units (GPUs), general-purpose GPUs (GPGPUs), non-scalar processors, highly-parallel processors, artificial intelligence (AI) processors, inference engines, machine learning processors, neural processing units (NPUs), intelligence processing units (IPUs), and other multithreaded processing units). In at least some implementations, the AP 104 is a dedicated GPU, one or more GPUs including several devices, or one or more GPUs integrated into a larger device. Additionally, the AP 104, in at least some implementations, includes specialized processors such as digital signal processors (DSPs), field programmable gate arrays (FPGAs), and application-specific integrated circuits (ASICs), which can also be configured for parallel processing tasks.

In at least some implementations, each processor implemented by the AP 104 is constructed as a multi-chip module (e.g., a semiconductor die package) that includes two or more base integrated circuit (IC) dies communicably coupled together with bridge chips or other coupling circuits. This configuration allows the processor to function as a single, addressable semiconductor integrated circuit. Additionally, in some implementations, the processors include one or more base IC dies that employ processing chiplets. These base dies are formed as a single semiconductor chip, incorporating an N number of communicably coupled graphics processing stacked die chiplets. Furthermore, in at least some implementations, the base IC dies include two or more direct memory access (DMA) engines that coordinate DMA transfers of data between devices and memory, or between different locations within memory.

The memories 106, 108 include any of a variety of random access memories (RAMs) or combinations thereof, such as a double-data-rate dynamic random access memory (DDR DRAM), a graphics DDR DRAM (GDDR DRAM), and the like. The AP 104 communicates with the host processor 102, the device memory 106, and the system memory 108 via a communications infrastructure 110, such as a bus. The communications infrastructure 110 interconnects the components of the processing system 100 and includes one or more of a peripheral component interconnect (PCI) bus, extended PCI (PCI-E) bus, advanced microcontroller bus architecture (AMBA) bus, advanced graphics port (AGP), or other such communication infrastructure and interconnects. In some implementations, communications infrastructure 110 also includes an Ethernet network or any other suitable physical communications infrastructure that satisfies an application's data transfer rate requirements.

As illustrated, the host processor 102 performs various functions, such as executing one or more applications 112 to generate graphic commands and managing a user mode driver (UMD) 114, a kernel mode driver (KMD) 116, or other drivers. In at least some implementations, the one or more applications 112 include applications that utilize the functionality of the AP 104. An application 112, in at least some implementations, includes one or more graphics instructions that instruct the AP 104 to render a graphical user interface (GUI) and/or a graphics scene. For example, the graphics instructions may include instructions that define a set of one or more graphics primitives to be rendered by AP 104.

In at least some implementations, the application 112 utilizes a graphics application programming interface (API) 118 to invoke the UMD 114 (or a similar accelerated processor driver). The UMD 114 issues one or more commands to the AP 104 for rendering one or more graphics primitives into displayable graphics images. Based on the graphics instructions issued by the application 112 to the UMD 114, the UMD 114 formulates one or more graphics commands that specify one or more operations for the AP 104 to perform for rendering graphics. In at least some implementations, the UMD 114 is a part of the application 112 running on the host processor 102. In one example, the UMD 114 is part of a gaming application running on the host processor 102. Similarly, the KMD 116 may be part of an operating system running on the host processor 102. The graphics commands generated by the UMD 114 include graphics commands intended to generate an image or a frame for display. The UMD 114 translates standard code received from the API 118 into a native format of instructions understood by the AP 104. The UMD 114 is typically written by the manufacturer of the AP 104. Graphics commands generated by the UMD 114 are sent to AP 104 for execution. The AP 104 executes the graphics commands and uses the results to control what is displayed on a display screen.

In at least some implementations, the host processor 102 sends commands 120, such as graphics commands, compute commands, or a combination thereof, intended for the AP 104 (or another processor) to a command buffer 122. Although depicted in FIG. 1 as a separate component for ease of illustration, the command buffer 122, in at least some implementations, is located in device memory 106, system memory 108, or a separate memory coupled to the communication infrastructure 110. The command buffer 122 temporarily stores a stream of graphics or other commands 120 that include input to the AP 104 (or another processor). The stream of commands 120 includes, for example, one or more command packets and/or one or more state update packets.

The AP 104, in at least some implementations, accepts both compute commands and graphics rendering commands from the host processor 102. For example, in at least some implementations, the AP 104 executes commands and programs for selected functions, such as graphics operations and other operations that are particularly suited for parallel processing. In general, the AP 104 is frequently used for executing graphics pipeline operations, such as pixel operations, geometric computations, and rendering an image to a display. In some implementations, the AP 104 also executes compute processing operations (e.g., those operations unrelated to graphics such as video operations, physics simulations, computational fluid dynamics, etc.), based on commands or instructions received from the host processor 102. For example, such commands include special instructions that are not typically defined in the instruction set architecture (ISA) of the AP 104. In some implementations, the AP 104 receives an image geometry representing a graphics image, along with one or more commands or instructions for rendering and displaying the image. In various implementations, the image geometry corresponds to a representation of a two-dimensional (2D) or three-dimensional (3D) computerized graphics image.

In various implementations, the AP 104 includes one or more processing units 124 (illustrated as processing unit 124-1 and processing unit 124-2). One example of a processing unit 124 is a workgroup processor (WGP) 124-2. In at least some implementations, a WGP 124-2 is part of a shader engine (not shown) of the AP 104. Each of the processing units 124 includes one or more compute units 126 (illustrated as compute unit 126-1 and compute unit 126-2), such as one or more stream processors (also referred to as arithmetic-logic units (ALUs) or shader cores), one or more single-instruction multiple-data (SIMD) units, one or more logical units, one or more scalar floating point units, one or more vector floating point units, one or more special-purpose processing units (e.g., inverse-square root units, since/cosine units, or the like), a combination thereof, or the like. Stream processors are the individual processing elements that execute shader or compute operations.

Multiple stream processors are grouped together to form a compute unit, a SIMD unit, a Single Instruction, Multiple Threads (SIMT) unit, or the like. SIMD and SIMT units, in at least some implementations, are each configured to execute a thread concurrently with the execution of other threads in a wavefront (e.g., a collection of threads that are executed in parallel) by other SIMD or SIMT units, e.g., according to a SIMD or SIMT execution model. In the SIMD execution model, multiple processing elements share a single instruction stream (program control flow unit) and program counter, executing the same instruction but on different pieces of data simultaneously. In the SIMT execution model, multiple threads share a single instruction stream and program counter, allowing them to execute the same program but with different data. This model is particularly efficient in handling divergent execution paths within the same group of threads. The number of compute units 126 in a SIMD or SIMT unit can be configured, allowing flexibility in performance and resource utilization depending on the specific computational requirements.

Each of the one or more processing units 124 executes a respective instantiation of a work item (e.g., a thread) to process incoming data. A work item is the basic unit of execution within these processing units 124, which represents a single instance of parallel execution, such as a collection of threads executed simultaneously as a “wavefront” on a single SIMD unit. In some implementations, wavefronts are interchangeably referred to as warps, vectors, or threads and include multiple work items that execute simultaneously in line with the SIMD execution model (e.g., one instruction control unit executing the same stream of instructions with multiple data). A work item executes at one or more processing elements within the compute units 126 as part of a workgroup executing within a processing unit 124.

The AP 104, through a hardware scheduler (HWS) 128, is configured to schedule and manage the execution of these wavefronts across different processing units 124 and compute units 126. The HWS 128 performs various operations, such as dispatching commands, managing queues, balancing loads, tracking resources, and orchestrating the execution of tasks on the AP 104. In at least some implementations, the HWS 128 is implemented using one or more hardware components, circuitry, firmware, or a firmware-controlled microcontroller, or a combination thereof. The HWS 128 may include components such as command processors, dispatch units, queue managers, load balancers, resource trackers, hardware timers and counters, priority handling components, interrupt handlers, power management controllers, or the like.

In at least some implementations, the processing system 100 also includes one or more command processors 130 that act as an interface between the host processor 102 and the AP 104. The command processor 130 receives commands from the host processor 102 and pushes them into the appropriate queues or pipelines for execution. The HWS 128 schedules the queued work items derived from these commands for execution on the appropriate resources, such as the compute units 126, within the AP 104. Examples of work items include a task, a thread, a wavefront, a warp, an instruction, or the like. In at least some implementations, the HWS 128 and the command processor 130 are separate components, whereas, in other implementations, the HWS 128 and the command processor 130 are the same component. Also, in at least some implementations, one or more of the processing units 124 include additional schedulers. For example, a WGP 124-2, in at least some implementations, includes a local scheduler (not shown) that, among other things, allocates work items to the compute units 126-2 of the WGP 124-2.

In at least some implementations, the AP 104 includes a memory cache hierarchy (not shown) including, for example, L1 cache and a local data share (LDS), to reduce latency associated with off-chip memory access. The LDS is a high-speed, low-latency memory private to each processing unit 124. In some implementations, the LDS is a full gather/scatter model so that a workgroup writes anywhere in an allocated space.

The parallelism afforded by the one or more processing units 124 is suitable for graphics-related operations such as pixel value calculations, vertex transformations, tessellation, geometry shading operations, and other graphics operations. A graphics processing pipeline 132 accepts graphics processing commands from the host processor 102 and thus provides computation tasks to the one or more processing units 124 for execution in parallel. In at least some implementations, the graphics pipeline 132 includes a number of stages 134, including stage A 134-1, stage B 134-2, and through stage N 134-N, each configured to execute various aspects of a graphics command. Some graphics pipeline operations, such as pixel processing and other parallel computation operations, require that the same command stream or compute kernel be performed on streams or collections of input data elements. Respective instantiations of the same compute kernel are executed concurrently on multiple compute units 126 in the one or more processing units 124 to process such data elements in parallel. As referred to herein, for example, a compute kernel is a function containing instructions declared in a program and executed on a processing unit 124 of the AP 104. This function is also referred to as a kernel, a shader, a shader program, or a program.

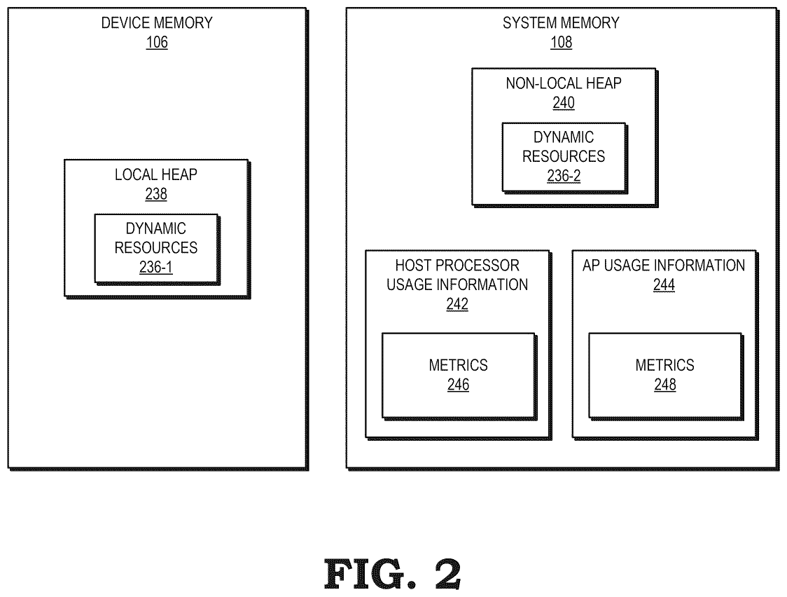

In some instances, the host processor 102 and the AP 104 manage dynamic resources 236 (also referred to herein as “resources 236”) to perform graphics rendering, as shown in FIG. 2. Dynamic resources 236 refer to various data structures, such as vertex buffers, constant buffers, textures, and the like, that are frequently updated by the host processor 102 and subsequently utilized as input by the AP 104 during rendering processes. These resources 236 help maintain real-time responsiveness and visual accuracy in graphics rendering, particularly as the game or application environment changes. In at least some implementations, dynamic resources 236-1 that are frequently updated by the AP 104 are maintained in the device memory 106 and dynamic resources 236-2 that are frequently updated by the host processor 102 are maintained in the system memory 108. However, other configurations are applicable depending on the specific requirements and performance considerations of the system 100.

Dynamic resources 236 are typically mapped using one or more memory management techniques, which optimize memory allocation and ensure efficient resource management within the system 100. For example, the host processor 102 updates dynamic resources 236 to reflect changes in the game or application environment, such as object movements, lighting adjustments, or texture updates. These resources are dynamic because they change frequently, often from one frame to the next. To efficiently handle these updates, the host processor 102, in at least some implementations, uses one or more mapping strategies that allow the host processor 102 to quickly obtain a virtual address for writing updated data without waiting for the AP 104 to finish processing the previous data. The immediate re-use of a recycle memory instance or allocation of a new memory instance, rather than reusing the existing one, helps prevent delays that could arise from synchronization conflicts between the host processor 102 and the AP 104.

In at least some implementations, when the host processor 102 needs to update a dynamic resource 236, it maps the resource into its address space using a write-discard access mode. This mapping process allocates a new memory instance or uses a recycled memory instance with a new memory address, ensuring that updated data can be written without overwriting the existing data that the AP 104 may still be accessing. This approach allows the AP 104 to continue its operations without interruption while the host processor 102 updates the resource. Once the AP 104 has completed its use of the old memory instance, that instance is marked as discardable and can be cleared or recycled for future use. This scenario exemplifies a “dynamic resource renaming instance”, where the dynamic resource 236 is effectively “renamed” through the allocation of a new (or recycled) memory instance, allowing the host processor 102 to avoid synchronization conflicts with the AP 104, thereby reducing stalls and ensuring efficient rendering.

The memory of the system 100, in at least some implementations, is organized into a plurality of memory heaps to optimize access for the host processor 102 and the AP 104. For example, in at least some implementations, a local memory heap 238 (e.g., an AP frame buffer) is located directly on the AP 104 in the device memory 106 and is optimized for fast AP 104 access, as shown in FIG. 2. The local memory heap 238 (also referred to herein as “local heap 238”) is configured for storing data that the AP 104 frequently accesses, including both dynamic and static resources, such as textures, vertex buffers, constant buffers, and framebuffer data. These types of data benefit from the low-latency access provided by the local heap 238, enabling the AP 104 to perform rendering tasks more efficiently. However, because the local heap 238 is optimized for AP 104 access, the host processor 102 accesses it more slowly.

On the other hand, a non-local memory heap 240 (also referred to herein as “non-local heap 240”) resides in system memory 108 and is more accessible to the host processor 102, as shown in FIG. 2. The non-local heap 240 provides a memory pool but is slower for the AP 104 to access, making it suitable for resources that are frequently updated or primarily managed by the host processor 102. This includes dynamic resources 236 that require constant changes, such as frequently updated vertex buffers and dynamic textures, as well as large data sets that the host processor 102 modifies regularly. These resources benefit from being in the non-local heap, where the host processor 102 can efficiently update them before they are accessed by the AP 104.

In many instances, graphics drivers or applications must determine where to allocate dynamic resources, such as either in the local heap 238 or in the non-local heap 240. This decision impacts performance, as accessing the local heap 238 is typically faster for the AP 104, while the host processor 102 often achieves better results by accessing the non-local heap 240. Conventional processing systems are typically configured to utilize a fixed preferred heap for dynamic resources, which generally leads to reduced performance, especially in complex three-dimensional (3D) games or cloud gaming scenarios. The optimal choice of memory location can shift depending on whether the system is currently limited by the host processor or AP performance, which can change dynamically based on factors like game scenes, resolution settings, or hardware configurations. For example, if the system is AP-bound, allocating resources in the non-local heap may slow down performance compared to using the local heap. Conversely, in a host processor-bound scenario, relying on the local heap rather than the non-local heap might degrade performance.

Therefore, the UMD 114 implements one or more adaptive heap choice techniques to select a preferred heap for newly requested renaming instances of dynamic resources 236, which optimizes performance by considering changes in the host processor 102 and AP 104 usage state. For example, the UMD 114 tracks host processor 102 and AP 104 usage to determine if the last N frames are host processor bound or AP bound. The UMD 114 selects a suitable heap for newly requested renaming instances of dynamic resources based on host processor usage information 242 and AP usage information 244, which is maintained in the system memory 108 or another storage location. It should be understood that although the following description is directed to the UMD 114 implementing the one or more adaptive heap choice techniques, this description is also applicable to other components of the computing system 100 as well. For example, in other implementations, an application 112 implements the one or more adaptive heap choice techniques such that the application 112 is able to select a suitable heap for performance based on the state of the host processor 102 and AP 104.

In at least some implementations, the host processor usage information 242 includes one or more host processor-based metrics 246 relating to the host processor's 102 usage of render-related threads, and the AP usage information 244 includes one or more AP-based metrics 248 relating to the AP's 104 graphics processing activities (e.g., usage of a 3D engine). The UMD 114, in at least some implementations, obtains the host processor-based metrics 246 by gathering real-time data on the clock speed of each core of the host processor 102. For example, in at least some implementations, the UMD 114 uses a system API 118 that retrieves current operating frequencies. The clock speed of each core can vary based on factors including workload, power settings, and thermal conditions. By obtaining this real-time information, the UMD 114 captures the exact frequency at which each core is running at the time of measurement.

The UMD 114 then determines the host processor workload for each thread associated with rendering. In at least some implementations, this is achieved by querying the number of host processor cycles each thread has consumed. The UMD 114, in at least some implementations, uses a system API 118 to access this information and determine how much processing each thread has performed. The busy cycles represent the work done by a thread and provide an understanding of how processing power is distributed across multiple threads. In at least some implementations, the UMD 114 calculates the actual host processor time consumed by a specific thread based on computing the difference (or delta) in host processor cycles over a period. This delta reflects the amount of work the thread has done between two points in time. The host processor time is then estimated by dividing this delta by the maximum clock speed across all host processor cores. For example, if the delta of the host processor busy cycles is 1,000,000 cycles and the maximum clock speed is 2.5 GHz (2,500,000,000 cycles per second), the host processor busy time can be approximated as:

$$Host Processor Busy Time \approx \frac{1 , 000 , 000 cycles}{2 , 500 , 000 , 000 cycles per second} \approx 0.0004 seconds . \qquad ( EQ . 1 )$$

The maximum clock speed is used to normalize the calculation, which ensures consistency across cores that may be operating at different frequencies.

The UMD 114 then calculates the host processor usage percentage for the target thread by comparing the host processor time to the total elapsed time over the measurement period. This percentage represents how much of the available host processor time was spent on the thread's tasks, which provides an indication of its resource consumption. For example, if the total time elapsed during which the busy cycles were measured is 0.01 seconds, the host processor usage percentage would be:

$$Host Processor Usage Percentage = \frac{0.0004 seconds}{0.01 seconds} \times 100 \approx 4 \% . \qquad ( EQ . 2 )$$

The UMD 114 then stores the calculated host processor usage as part of the host processor-based metrics 246.

Alternatively, or in addition to the process above, the UMD 114, in at least some implementations, obtains the host processor-based metrics 246 based on real-time performance counter data. For example, the UMD 114 obtains the performance counter clock using a system API 118, which provides a high-resolution timing reference. At the end of each frame, the UMD 114 retrieves the number of host processor cycles, time ticks, and the current host processor clock frequency. The UMD 114 then calculates the host processor busy time on the main render thread by determining the difference in host processor cycles between the end of the current frame and the previous frame and dividing this difference by the current host processor clock frequency, as represented by:

$$ProcessBusyTimeOnMainRenderThread = \frac{CycleOnFrameEnd - CyclesOnLastFrameEnd}{CurrentProcessorClockInMHz} . \qquad ( EQ . 3 )$$

Simultaneously, the UMD 114 calculates the total time for the frame by taking the difference in time ticks and dividing by the performance counter clock, as represented by:

$$TotalTime = \frac{TicksOnFrameEnd - TicksOnLastFrameEnd}{PerfCounterClkInMHz} . \qquad ( EQ . 4 )$$

The UMD 114 calculates the host processor usage on the main render thread by dividing the host processor busy time by the total time as represented by:

$$ProcessorUsageOnMainThread = \frac{ProcessorBusyTimeOnMainRenderThread}{TotalTime} . \qquad ( EQ . 5 )$$

This approach yields a measure of the thread's resource consumption, which is then stored as part of the host processor-based metrics 246.

The UMD 114, in at least some implementations, obtains the AP-based metrics 146 related to graphics processing activities of the AP 104 by preparing command buffers 122, which are data structures including a sequential collection of AP commands that indicate the operations the AP 104 is to perform. In this context, the UMD 114 constructs these command buffers 122 for the graphics processing activities of the AP 104, which is tasked with executing 3D rendering operations, such as drawing shapes, processing textures, and handling lighting calculations. Each command buffer 122 encapsulates a set of instructions or commands 120 (illustrated as command 120-1 to command 120-N) that the AP 104 will process in the order they appear. It should be understood that although the following description uses 3D engine usage as one example of graphics processing activities performed by the AP 104, other graphics processing activities are applicable as well.

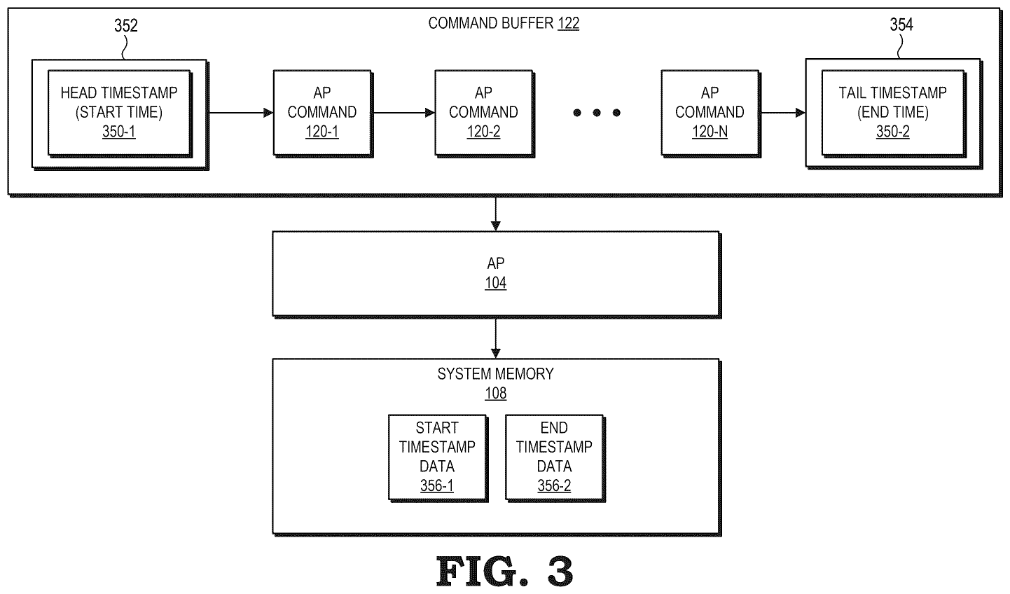

The UMD 114 then inserts timestamp packets 350 into each command buffer 122 to monitor and measure the graphics processing activities of the AP 104, as shown in FIG. 3. In at least some implementations, these timestamp packets 350 are asynchronous. The timestamp packets 350, in at least some implementations, are configured to operate independently of the AP's 104 normal command execution, which ensures they do not interfere with the processing of the main instructions. As shown in FIG. 3, the UMD 114, in at least some implementations, places a first timestamp packet 350-1 at the very beginning 352 of the command buffer 122, referred to as the “head” or “head position”, to capture the moment when the AP 104 begins processing the buffer 122. Similarly, the UMD 114 inserts a second timestamp packet 350-2 at the very end 354 of the command buffer 122, known as the “tail” or “tail position”, which records the moment when the AP 104 finishes executing all the commands. By embedding these timestamp packets 350, the UMD 114 sets up the necessary markers to measure the duration of the AP's processing time (execution duration) for that particular command buffer 122. The UMD 114 also sets up specific memory addresses where the AP 104 will store timestamp data. These addresses are in the device memory 106, the system memory 108, or cache, depending on where the UMD 114 needs to retrieve the data later.

When the AP 104 begins executing the command buffer 122, the AP 104 first encounters the head timestamp packet 350-1. When the AP 104 encounters the head timestamp packet 350-1, the AP 104 records the current value of its internal clock as start timestamp data 356-1 at the memory address specified by the UMD 114. This recorded value represents the start time of the command buffer's execution. The AP 104 then proceeds to execute all the commands 120 within the command buffer 122, performing tasks such as rendering 3D objects, applying textures, and calculating lighting effects as directed by the UMD 114. After processing all the commands 120, the AP 104 reaches the tail timestamp packet 350-2. Upon encountering this packet 350-2, the AP 104 records the current time as end timestamp data 356-2 at another memory address designated by the UMD 114 for this purpose, marking the end of the command buffer's execution.

The UMD 114 then retrieves these two recorded timestamps 356 from the specified memory locations to determine how long the GPU's 3D engine was actively engaged in processing the commands within the buffer 122. For example, after both the start and end timestamps 356 are recorded for a command buffer 122, the UMD 114 calculates the execution time for that command buffer 122. In at least some implementations, the UMD 114 subtracts the start timestamp 356-1 recorded at the head (start) from the end timestamp 356-2 recorded at the tail (end) and divides this by engine use frequency. The resulting value represents the total time taken by the AP's 3D engine to execute all the commands 120 within that particular command buffer 122. This execution time reflects the active duration during which the AP 104 was processing 3D tasks, providing a measure of the workload handled by the 3D engine for that specific command buffer 122. In another example, the UMD 114 repeats this calculation for each command buffer 122 to determine the execution time for all command buffers 122 processed by the AP 104.

In another implementation, the AP counter is used to determine AP usage. For example, the AP 104 begins executing the command buffer 122, the AP 104 first encounters the head timestamp packet 350-1. Upon encountering the head timestamp packet 350-1, the AP 104 records the current value of its internal counter as start timestamp data 356-1 at the memory address specified by the UMD 114. This recorded value represents the start time of the command buffer's execution. The AP 104 then proceeds to execute all the commands within the command buffer 122, performing tasks such as rendering 3D objects, applying textures, and calculating lighting effects as directed by the UMD 114. During this process, the AP counter values are tracked for each command executed. These individual counter values are summed to determine the cumulative AP resource usage across all commands within the buffer 122. After processing all the commands, the AP 104 reaches the tail timestamp packet 350-2. Upon encountering this packet, the AP 104 records the current AP counter value as end timestamp data 356-2 at another memory address designated by the UMD 114, marking the end of the command buffer's execution. To evaluate AP utilization during this period, the cumulative AP resource usage (sum of the counters per command) is divided by the total counter value, providing insight into how efficiently the AP capacity was used during the execution of the command buffer 122.

In scenarios where the AP 104 processes multiple command buffers 122 in succession, the UMD 114 aggregates the execution times across these buffers 122. For example, if there are N continuous command buffers 122, all executed by the AP 104, each buffer 122 will have an associated execution time calculated by the UMD 114 in the previous step. To assess the overall usage of the AP's 3D engine, the UMD 114 sums the execution times of all these command buffers 122 together. This sum represents the total active time that the AP's 3D engine spent executing commands across all the buffers 122. By aggregating the execution times in this manner, the UMD 114 obtains a comprehensive view of the AP's workload over the series of command buffers 122, capturing the cumulative time the 3D engine was in use.

In at least some implementations, to quantify the AP's 3D engine usage over the given time period, the UMD 114 divides the total active time (sum of all command buffer execution times) by the total time period during which these command buffers 122 were processed. The UMD 114, in at least some implementations, defines the total time period as the span from when the AP 104 started executing the first command buffer 122 to when it completed the last one. By dividing the total active time by the total time period, the UMD 114 calculates a usage metric that reflects the proportion of time the AP's 3D engine was actively engaged in processing commands, as represented by.

$$APUsage = \frac{{\sum }_{i = 1}^{m} {t}_{i}}{Total Time} , \qquad ( EQ . 6 )$$

where tᵢ represents the execution time of the ith command buffer 122, m is the total number of command buffers, and Total Time is the total period from the start of the first command buffer 122 to the end of the last command buffer 122. This metric, expressed as a percentage or ratio, provides a clear indication of how effectively the AP's 3D engine is being utilized during the execution of the command buffers 122 and is stored as part of the AP-based metrics 248.

When an application 112 requests a new instance of a dynamic resource 236, the application 112 signals the need for a new memory-intensive data structure, such as a texture or buffer, that will be used in rendering or computation. The request, in at least some implementations, includes specific parameters about the size of the resource, its intended use (e.g., write-discard), and the like. In response to detecting the request from the application 112, the UMD 114 checks the last N frames for the host processor or AP bound status to determine whether the application 112 or system is more limited by the host processor 102 or the AP 104. This assessment is based on the previously calculated host processor usage information 242 and AP usage information 244.

In at least some implementations, the UMD 114 performs this assessment using a sliding window of the last N frames, where N is a configurable parameter that helps balance the responsiveness to recent performance trends against stability from minor fluctuations. If the host processor usage information 242 and AP usage information 244 for the last N frames indicate that the host processor 102 has been consistently near full utilization while the AP 104 remains underutilized, the UMD 114 determines that the application 112 is host processor-bound. For example, if the host processor 102 utilization is greater than the AP 104 utilization by a threshold amount, the UMD 114 determines that the application 112 is host processor-bound. In contrast, if the host processor usage information 242 and AP usage information 244 for the last N frames indicate that the AP 104 has been consistently near full utilization while the host processor 102 remains underutilized or is less active, the UMD 114 determines that the application 112 is AP-bound. For example, if the AP processor 104 utilization is greater than the host processor 102 utilization by a threshold amount, the UMD 114 determines that the application 112 is AP-bound.

Based on this analysis, the UMD 114 makes a decision. If the application 112 is AP-bound, meaning the AP 104 is the primary bottleneck, the UMD 114 allocates the new or recycled resource 236 in the local heap 238 (e.g., the AP's frame buffer (FB) or video RAM (VRAM)). By placing the resource in the local heap 238, the AP 104 can access the resource 236 more efficiently, which leads to faster processing and smoother frame rates, especially when the AP 104 is under heavy load. On the other hand, if the application 112 is host processor-bound, where the host processor 102 is the bottleneck, the UMD 114 allocates the new or recycled resource 236 in the non-local heap 240. This allocation results in faster write speed compared to using a local heap and reduces the overhead associated with transferring data between the host processor 102 and the AP 104, thus optimizing performance when the host processor 102 is handling the majority of the workload. This strategy ensures that the host processor 102 can efficiently manage dynamic resources 236, particularly those that undergo frequent updates or modifications.

In at least some implementations, if the analysis does not clearly indicate that the application 112 is either host processor-bound or AP-bound, the UMD 114 defaults to allocating the resource 236 in a preferred or default memory heap (also referred to herein as “default heap”). This fallback strategy, in at least some implementations, is based on general heuristics, system settings, or the specific type of resource 236 being allocated. The default heap is chosen to provide balanced performance, which ensures that the resource 236 is allocated in a memory location that should perform adequately across various scenarios.

After the UMD 114 has selected the appropriate heap based on whether the application is host processor-bound, AP-bound, or neither, the UMD 114 allocates the resource instance or uses a recycled resource instance in that selected heap and then returns it to the application 112. In at least some implementations, this involves creating the necessary memory structures within the selected heap and ensuring that the resource 236 is fully initialized and ready for use. The application 112 then receives a reference or handle to the newly allocated or recycled resource 236, which it can integrate into its rendering or computational pipeline, leveraging the optimized memory location to maintain or improve performance.

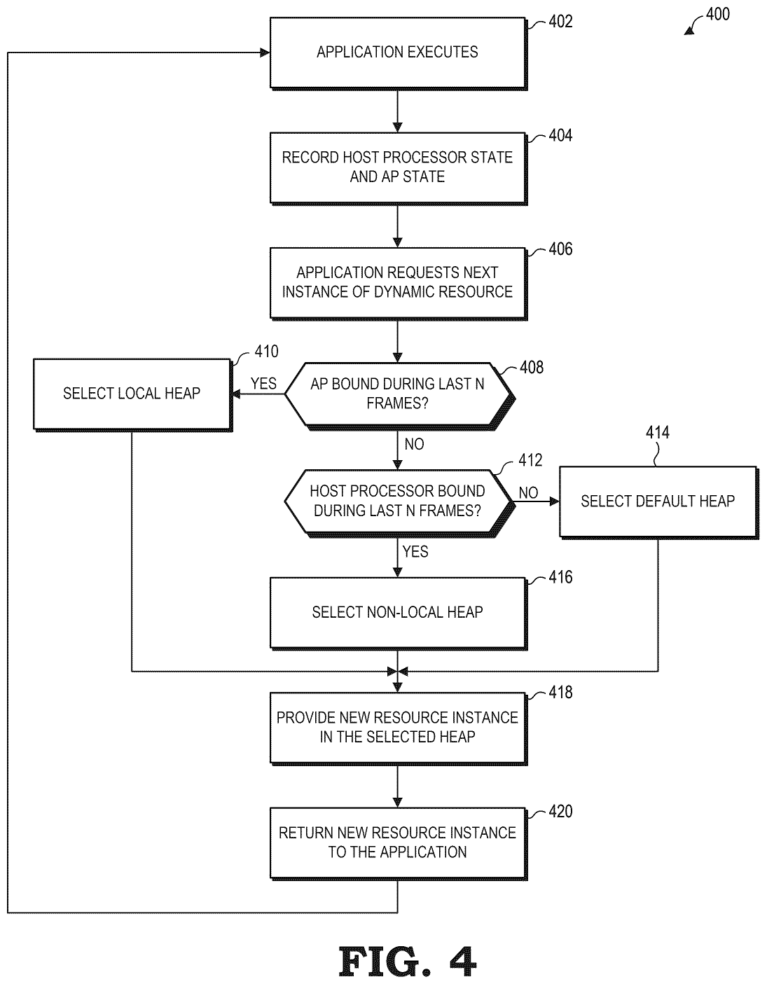

FIG. 4 is a diagram illustrating an example method 400 of an overall process for performing adaptive heap selection for dynamic resources 236. It should be understood that the processes described below with respect to method 400 have been described above in greater detail with reference to FIG. 1 to FIG. 3. For purposes of description, the method 400 is described with respect to an example implementation at the computing system 100 of FIG. 1, but it will be appreciated that, in other implementations, the method 400 is implemented at processing devices having different configurations. Also, the method 400 is not limited to the sequence of operations shown in FIG. 4, as at least some of the operations can be performed in parallel or in a different sequence. Moreover, in at least some implementations, the method 400 can include one or more different operations than those shown in FIG. 4.

At block 402, an application 112 begins or continues to execute at the processing system 100. At block 404, the UMD 114 records the state of the host processor 102 and the AP 104. For example, as the application 112 executes, the UMD 114 records host processor usage information 242 relating to the host processor's 102 usage of render related threads and records AP usage information 244 relating to the AP's usage of a 3D engine.

At block 406, the application 112 identifies the need for an additional or new instance of a dynamic resource 236 and submits a request for its allocation. This request typically arises when the application 112 is processing new data, rendering additional frames, or performing tasks that require separate memory allocations for efficient operation. The dynamic resource 236, which could be a texture, buffer, or similar memory-intensive structure, is expected to change or be updated frequently during runtime. Therefore, the application 112 signals to the UMD 114 or another component that it needs this new resource instance to handle the increased or varying workload. The request, in at least some implementations, includes specific details about the resource, such as its size, intended usage (e.g., read-only, read-write), and any preferred memory location.

At block 408, the UMD 114 determines, based on the host processor usage information 242 and the AP usage information 244, if the last N frames of the application's rendering or processing pipeline were AP-bound. At block 410, if the UMD 114 determines that the last N frames were AP-bound, the UMD 114 selects the local heap 238 for the newly requested instance of the dynamic resource 236. The process then continues to block 418. At block 412, if the UMD 114 determines that the last N frames were not AP-bound, the UMD 114 determines if the last N frames were host processor-bound. At block 414, if the last N frames were not AP-bound or host-processor bound, the UMD 114 selects a default head for allocating the dynamic resource 236. The default heap, in at least some implementations, is designated by the processing system 100, the application 112, the UMD 114, or the like. The default heap is either the local heap 238, the non-local heap 240, or the like. The process then continues to block 418.

At block 416, if the last N frames were host processor bound, the UMD 114 selects the non-local heap 240 for allocating the requested dynamic resource 236. At block 418, after the UMD 114 has selected the local heap 238, the non-local heap 240, or the default heap, the UMD 114 provides the new instance of the requested dynamic resource 236 in the selected heap. At block 420, the UMD 114 then returns the requested instance of the dynamic resource 236 to the application 112. For example, the UMD 114 provides a reference or handle to the resource 236, which the application 112 can use to interact with the newly created or recycled resource in its rendering or computational operations. The process then ends or returns to block 402.

In some embodiments, the apparatus and techniques described above are implemented in a system including one or more integrated circuit (IC) devices (also referred to as integrated circuit packages or microchips). Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
responsive to a request for a dynamic resource, selecting a memory heap from a plurality of memory heaps based on processor usage information; and
allocating an instance of dynamic resource in the selected memory heap.

2. The method of claim 1, wherein the processor usage information comprises host processor usage information and accelerated processor usage information.

3. The method of claim 1, wherein selecting the memory heap comprises:
selecting, based on the processor usage information, one of a local memory heap within device memory of an accelerated processor, a non-local memory heap within system memory, or a default memory heap.

4. The method of claim 1, wherein selecting the memory heap comprises:
responsive to the processor usage information indicating that a number of previous frames associated with an application requesting the dynamic resource are accelerated processor-bound, selecting a local memory heap within device memory of the accelerated processor.

5. The method of claim 1, wherein selecting the memory heap comprises:
responsive to the processor usage information indicating that a number of previous frames associated with an application requesting the dynamic resource are host processor-bound, selecting a non-local memory heap within system memory associated with the host processor.

6. The method of claim 1, wherein selecting the memory heap comprises:
responsive to the processor usage information indicating that a number of previous frames associated with an application requesting the dynamic resource is neither accelerated processor-bound or host processor-bound, selecting a default memory heap.

7. The method of claim 1, further comprising:
querying, for a host processor, real-time host processor clock data and host processor clock cycles for render-related threads;
calculating host processor usage information for the render-related threads based on the queried real-time host processor clock data and host processor clock cycles; and
storing the host processor usage information as part of the processor usage information.

8. The method of claim 1, further comprising:
inserting a first timestamp packet at a head position of one or more command buffers and a second timestamp packet at a tail position of the one or more command buffers associated with an accelerated processor;
responsive to executing the one or more command buffers, storing, by the accelerated processor, a first timestamp associated with the first timestamp packet and a second timestamp associated with the second timestamp packet for each of the one or more command buffers;
calculating accelerated processor usage information for the accelerated processor based an execution duration of the one or more command buffers represented by a difference between the first timestamp and the second timestamp for each of the one or more command buffers; and
storing the accelerated processor usage information as part of the processor usage information.

9. A processing system, comprising:
a host processor couplable to an accelerated processor;
a plurality of memory heaps;
the host processor configured to:
responsive to a request for a dynamic resource, select a memory heap from the plurality of memory heaps based on processor usage information; and
allocate an instance of the dynamic resource in the selected memory heap.

10. The processing system of claim 9, wherein the processor usage information comprises processor usage information for the host processor and processor usage information for the accelerated processor.

11. The processing system of claim 9, wherein the host processor is configured to select the memory heap by:
selecting, based on the processor usage information, one of a local memory heap within device memory of the accelerated processor, a non-local memory heap within system memory, or a default memory heap.

12. The processing system of claim 9, wherein the host processor is configured to select the memory heap by:
responsive to the processor usage information indicating that a number of previous frames associated with an application requesting the dynamic resource are accelerated processor-bound, selecting a local memory heap within device memory of the accelerated processor.

13. The processing system of claim 9, wherein the host processor is configured to select the memory heap by:
responsive to the processor usage information indicating that a number of previous frames associated with an application requesting the dynamic resource are host processor-bound, selecting a non-local memory heap within system memory associated with the host processor.

14. The processing system of claim 9, wherein the host processor is configured to select the memory heap by:
responsive to the processor usage information indicating that a number of previous frames associated with an application requesting the dynamic resource is neither accelerated processor-bound or host processor-bound, selecting a default memory heap.

15. The processing system of claim 9, wherein the host processor is further configured to:
query, for the host processor, real-time host processor clock data and host processor clock cycles for render-related threads;
calculate host processor usage information for the render-related threads based on the queried real-time host processor clock data and host processor clock cycles; and
store the host processor usage information as part of the processor usage information.

16. The processing system of claim 9, wherein the host processor is further configured to:
insert a first timestamp packet at a head position of one or more command buffers and a second timestamp packet at a tail position of the one or more command buffers associated with the accelerated processor,
the accelerated processor configured to:
responsive to execution of the one or more command buffers, store a first timestamp associated with the first timestamp packet and a second timestamp associated with the second timestamp packet for each of the one or more command buffers,
the host processor further configured to:
calculate accelerated processor usage information for the accelerated processor based an execution duration of the one or more command buffers represented by a difference between the first timestamp and the second timestamp for each of the one or more command buffers; and
store the accelerated processor usage information as part of the processor usage information.

17. A processing system, comprising:
a host processor couplable to an accelerator processor;
a plurality of memory heaps; and
memory configured to store a user mode driver that is configured to manipulate at least one of the host processor and the accelerated processor to:
monitor host processor usage associated with render-related threads;
monitor accelerated processor usage associated with graphics processing activities;
responsive to receiving a request from an application for a dynamic resource, select a memory heap from the plurality of memory heaps based on the host processor usage and the accelerated processor usage; and
allocate an instance of the dynamic resource in the selected memory heap.

18. The processing system of claim 17, wherein the user mode driver is configured to select the memory heap by:
responsive to the host processor usage and the accelerated processor usage indicating that a number of previous frames associated with an application requesting the dynamic resource are accelerated processor-bound, selecting a local memory heap within device memory of the accelerated processor.

19. The processing system of claim 17, wherein the user mode driver is configured to select the memory heap by:
responsive to the host processor usage and the accelerated processor usage indicating that a number of previous frames associated with the application requesting the dynamic resource are host processor-bound, selecting a non-local memory heap within system memory associated with the host processor.

20. The processing system of claim 17, wherein the user mode driver is configured to select the memory heap by:
responsive to the host processor usage and the accelerated processor usage indicating that a number of previous frames associated with the application requesting the dynamic resource is neither accelerated processor-bound or host processor-bound, selecting a default memory heap.
